(19) United States
(12) Patent Application Publication
(10) Pub. No.: US 2008/0084943 A1
(43) Pub. Date: Apr. 10, 2008

(54) Apparatus and method for estimating channels in mobile communication system by using hidden pilots

(75) Inventors: Sung-Yoon Jung, Seoul (KR); Sang-Boh Yun, Seognam-si (KR); Young-Hoon Kwon, Seongnam-si (KR)

Correspondence Address: DOCKET CLERK, P.O. DRAWER 800889, DALLAS, TX, 75380, US

(73) Assignee: SAMSUNG ELECTRONICS Co., LTD., Suwon-si (KR)

(21) Appl. No.: 11/903,504

(22) Filed: Sep. 21, 2007

(30) Foreign Application Priority Data
Sep. 22, 2006 (KR) 2006-0092068

(51) Int. Cl. H04J 11/00; H04L 27/28

(52) U.S. Cl. 375/260; 370/203; 370/210

(57) ABSTRACT

Provided is an apparatus and method for estimating channels in a mobile communication system by using hidden pilots. In a method for transmitting data in the mobile communication system, a precoding signal and a hidden pilot are generated using a sequence with auto & cross-correlation characteristics. A user signal is modulated in a predetermined modulation scheme and is precoded using the precoding signal. The hidden pilot is added to the precoded signal. Therefore, a waste of bandwidth due to the use of the conventional pilot signal is reduced and a data rate is increased, thereby increasing the overall transmission efficiency of the system and reducing the PAPR002E.

### CROSS-REFERENCE TO RELATED APPLICATION(S) AND CLAIM OF PRIORITY

The present application claims priority under 35 U.S.C. §119 to an application filed in the Korean Intellectual Property Office on Sep. 22, 2006 and allocated Serial No. 2006-0092068, the contents of which are incorporated herein by reference.

### TECHNICAL FIELD OF THE INVENTION

The present invention relates generally to a mobile communication system, and in particular, to an apparatus and method for estimating channels using hidden pilots.

### BACKGROUND OF THE INVENTION

An Orthogonal Frequency Division Multiple Access (OFDMA) system periodically transmits preambles and pilots (training signals) in order to estimate user channels. The periodic preambles and pilots are transmitted using the bandwidth of the data signal, which causes the periodic loss of bandwidth and affects the transmission efficiency of the system. In the case of a time-variant channel, for example, if a user moves at a high speed, a channel estimation error increases in the portion where a pilot is not transmitted, degrading the overall system performance such as a bit error rate (BER) and a packet error rate (PER). Therefore, researches have been conducted on methods for determining the optimal number and positions of pilots in order to minimize the bandwidth loss due to the use of the conventional pilots.

A Code Division Multiple Access (CDMA) system can minimize the bandwidth loss due to pilots because codes are separately allocated for estimation of respective user channels. However, there is no separate channel estimation code in the OFDMA system, which causes the bandwidth loss and affects the transmission efficiency greatly.

Also, many broadband user signals are simultaneously received in the uplink of the broadband OFDMA system, which greatly increases a peak-to-average power ratio (PAPR). Many schemes have been proposed to reduce the PAPR by using a single-carrier frequency division multiple access (FDMA) in the uplink. Such schemes, however, cause a greater inter-symbol interference (ISI) than the conventional OFDM scheme.

What is therefore required is a method for reducing the transmission efficiency degradation due to the use of the pilots and reducing the high PAPR in the uplink of the OFDMA system.

### SUMMARY OF THE INVENTION

To address the above-discussed deficiencies of the prior art, it is a primary object of the present invention to substantially solve at least the above problems and/or disadvantages and to provide at least the advantages below. Accordingly, an object of the present invention is to provide an apparatus and method for estimating channels in a mobile communication system by using hidden pilots.

Another object of the present invention is to provide an apparatus and method for generating, at a transmitting apparatus, a hidden pilot using a polyphase sequence, adding the hidden pilot to a transmit (TX) signal prior to transmission to a receiving apparatus, and estimating, at the receiving apparatus, a channel using the hidden pilot.

According to one aspect of the present invention, a method for transmitting data in a mobile communication system includes the steps of: modulating a symbol data to be transmitted in a predetermined modulation scheme; generating a hidden pilot using a sequence with auto and cross-correlation characteristics; precoding the modulated data with the precoding signal having the auto and cross-correlation characteristics; and adding the hidden pilot to the precoded signal.

According to another aspect of the present invention, an apparatus for transmitting data in a mobile communication system includes: a modulator for modulating a user signal in a predetermined modulation scheme; a precoder for precoding the modulated user signal using a precoding signal generated using a sequence with auto and cross-correlation characteristics; and a adder for adding a hidden signal, generated using the sequence, to the precoded signal.

According to still another aspect of the present invention, a method for receiving data in a mobile communication system includes the steps of: removing a cyclic prefix (CP) from a receive (RX) signal; and removing the remaining signal except a hidden pilot of a self-user from the CP-removed RX signal using a cyclic hidden pilot, and estimating a channel using only the hidden pilot of a self-user.

According to even another aspect of the present invention, an apparatus for receiving data in a mobile communication system includes: a CP remover for removing a CP from a receive (RX) signal; and a channel estimator for removing the remaining signal except a hidden pilot of a self-user from the CP-removed RX signal using a cyclic hidden pilot, and estimating a channel using only the hidden pilot of a self-user.

According to yet another aspect of the present invention, an apparatus for transceiving data in a mobile communication system includes: a receiving apparatus for estimating a channel using only a preamble, decoding a receive (RX) signal using the estimated channel, transmitting feedback information for transmission of a hidden pilot to a transmitting apparatus if there is an error in the decoding operation, receiving a TX signal having a hidden pilot added thereto from the transmitting apparatus after MAP information including information, which indicates that the hidden pilot is to be added to a TX signal prior to transmission to the receiving apparatus, is received from the transmitting apparatus, estimating a channel using the added hidden pilot, and decoding an RX signal using the estimated channel; and a transmitting apparatus for transmitting only a TX signal to the receiving apparatus, transmitting the MAP information to the receiving apparatus if the feedback information is received from the receiving apparatus, and transmitting the TX signal having the hidden pilot added thereto to the receiving apparatus.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

The above and other objects, features and advantages of the present invention will become more apparent from the following detailed description when taken in conjunction with the accompanying drawings in which:

FIG. 1A is a block diagram of a transmitting apparatus in an OFDMA mobile communication system according to an embodiment of the present invention;

FIG. 1B is a block diagram of a receiving apparatus in an OFDMA mobile communication system according to an embodiment of the present invention;

FIG. 2 is a flowchart illustrating a procedure for transmitting data from a transmitting apparatus in an OFDMA mobile communication system according to an embodiment of the present invention;

FIG. 3 is a flowchart illustrating a procedure for receiving data at a receiving apparatus in an OFDMA mobile communication system according to an embodiment of the present invention;

FIGS. 4A to 4E are diagrams for verifying whether precoders and hidden pilots according to the present invention satisfy characteristics necessary for channel estimation and receiver design;

FIG. 5 is a graph for comparing the NTE of the present invention with the NTE of the conventional art; and

FIG. 6 is a graph for comparing the PAPR of the present invention with the PAPR of the conventional art.

### DETAILED DESCRIPTION OF THE PREFERRED EMBODIMENTS

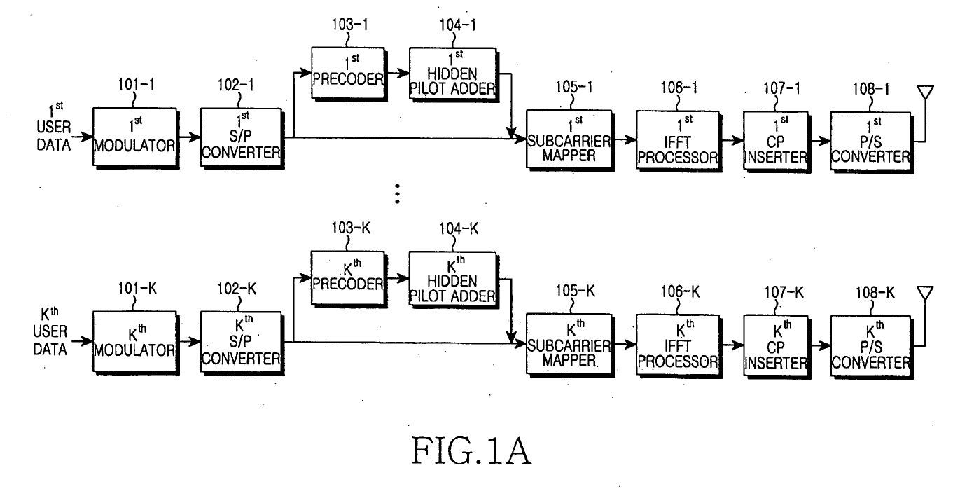

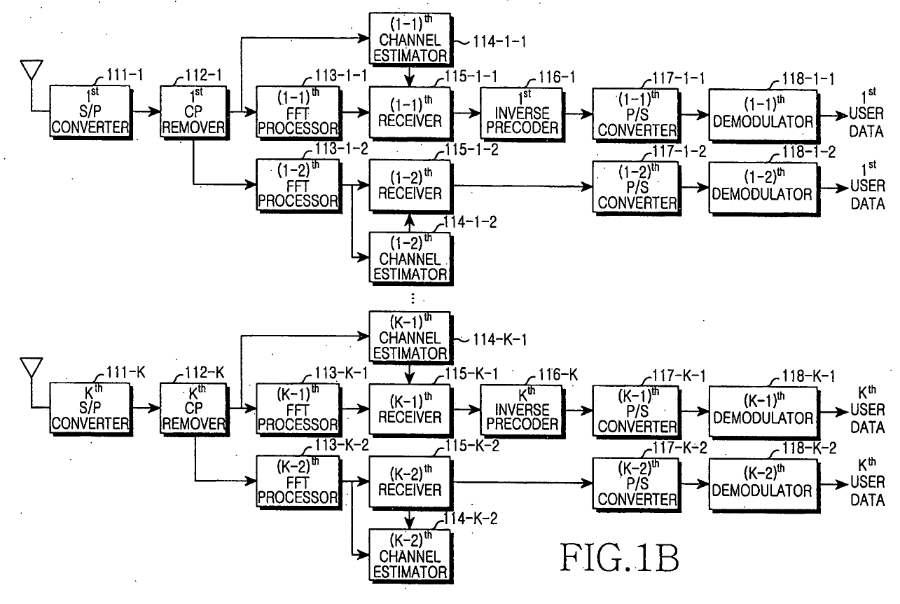

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The present invention is intended to provide an apparatus and method for estimating channels in a mobile communication system by using hidden pilots.

The present invention proposes a method for adding a hidden training signal (pilot) to a transmit (TX) signal prior to transmission to a receiving apparatus. The method for adding the hidden pilot to the TX signal prior to transmission to the receiving apparatus may be applied from the beginning independently of a decoding error in the receiving apparatus, or may vary depending on the decoding error. In this case, the location of a symbol to which the hidden pilot is added may be fixed. For example, the receiving apparatus estimates a channel using only a preamble and performs a decoding operation using the estimated channel. If there is a CRC error in the decoding operation, the receiving apparatus transmits feedback information such as a channel quality indicator (CQI) and a Negative ACKnowledgement (NACK) signal to the transmitting apparatus. Upon receipt of the feedback information from the receiving apparatus, the transmitting apparatus adds 1-bit information, which indicates that a hidden pilot is to be added to a TX signal, to MAP information prior to transmission to the receiving apparatus. Thereafter, the transmitting apparatus adds a hidden pilot to a TX signal prior to transmission to the receiving apparatus. At this point, TX power is shared by the TX signal and the hidden pilot added to the TX signal. The following description is made on the assumption that the hidden pilot adding method varies depending on the decoding error.

FIG. 1A is a block diagram of a transmitting apparatus in an orthogonal frequency division multiple access (OFDMA) mobile communication system according to an embodiment of the present invention. FIG. 1B is a block diagram of a receiving apparatus in the OFDMA mobile communication system according to the embodiment of the present invention.

Referring to FIG. 1A, for 1^{st}˜K^{th} user data, the transmitting apparatus includes 1^{st}˜K^{th} modulators 101-1˜101-K, 1^{st}˜K^{th} serial-to-parallel (S/P) converters 102-1˜102-K, 1^{st}˜K^{th} precoders 103-1˜103-K, 1^{st}˜K^{th} hidden pilot adders 104-1˜104-K, 1^{st}˜K^{th} subcarrier mappers 105-1˜105-K, 1^{st}˜K^{th} inverse fast Fourier transform (IFFT) processors 106-1˜106-K, 1^{st}˜K^{th} cyclic prefix (CP) inserters 107-1˜107-K, and 1^{st}˜K^{th} parallel-to-serial (P/S) converters 108-1˜108-K. Referring to FIG. 1B, the 1^{st}˜K^{th} receiving apparatus includes 1^{st}˜K^{th} S/P converters 111-1˜111-K, 1^{st}˜K^{th} CP removers 112-1˜112-K, (1-1)^{th} ˜(K-1)^{th} primary fast Fourier transform (FFT) processors 113-1-1˜113-K-1, (1-1)^{th}˜(K-1)^{th} primary channel estimators 114-1-1˜114-K-1, (1-1)^{th}˜(K-1)^{th} primary receivers 115-1-1˜115-K-1, 1^{st}˜K^{th} inverse precoders 116-1˜116-K, (1-1)^{th}˜(K-1)^{th} primary P/S converters 117-1-1˜117-K-1, (1-1)^{th}˜(K-1)^{th} primary demodulators 118-1-1˜118-K-1, (1-2)^{th}˜(K-2)^{th} (K-2)^{th} secondary FFT processors 113-1-2˜113-K-2, (1-2)^{th}˜(K-2)^{th} secondary channel estimators 114-1-2˜114-K-2, (1-2)^{th} (K-2)^{th} secondary receivers 115-1-2˜115-K-2, (1-2)^{th}˜(K-2)^{th} secondary P/S converters 117-1-2˜117-K-2, and (1-2)^{th} (K-2)^{th} secondary demodulators 118-1-2˜118-K-2.

Referring to FIG. 1A, the modulators 101-1˜101-K modulate the 1^{st}˜K^{th} user data in a predetermined modulation scheme (modulation order), and output the resulting signals to the S/P converters 102-1˜102-K. That is, the modulators 101-1˜101-K map the input 1^{st}˜K^{th} user data onto a constellation according to a predetermined mapping scheme, thereby outputting complex symbols. Examples of the modulation scheme include Binary Phase Shift Keying (BPSK) for mapping 1 bit (s=1) to one complex symbol, Quadrature Phase Shift Keying (QPSK) for mapping 2 bits (s=2) to one complex symbol, 8-ary Quadrature Amplitude Modulation (8QAM) for mapping 3 bits (s=3) to one complex symbol, and 16-ary Quadrature Amplitude Modulation (16QAM) for mapping 4 bits (s=4) to one complex symbol.

The S/P converters 102-1˜102-K convert input serial signals into parallel signals, and output the parallel signals to the subcarrier mappers 105-1˜105-K or the precoders 103-1˜103-K. For example, if feedback information such as a CQI and a NACK signal is received from the receiving apparatus, the above parallel signals are output to the precoders 103-1˜103-K in order to add hidden pilots to TX signals prior to transmission. On the other hand, if feedback information, such as a CQI and a NACK signal, is not received from the receiving apparatus, the above parallel signals are output to the subcarrier mappers 105-1˜105-K in order to transmit only pure TX signals.

The precoders 103-1˜103-K precode signals from the S/P converters 102-1˜102-K using precoding signals, which are designed using polyphase sequences, and output the precoded signals to the hidden pilot adders 104-1˜104-K. The hidden pilot adders 104-1˜104-K add hidden pilots, which are designed using the polyphase sequences, to the precoded signals, and output the resulting signals to the subcarrier mappers 105-1˜105-K.

The subcarrier mappers 105-1˜105-K map subcarriers, which are allocated to the users, to signals received from the S/P converters 102-1˜102-K or the hidden pilot adders 104-1˜104-K, and output the resulting signals to the IFFT processors 106-1˜106-K.

The IFFT processors 106-1˜106-K IFFT-process input signals into time-domain sample data, and output the time-domain sample data to the CP inserters 107-1˜107-K. The CP inserters 107-1˜107-K prefix a copy of a predetermined end of the sample data to the sample data, and output the resulting data to the P/S converters 108-1˜108-K. The P/S converters 108-1˜108-K convert input parallel signals into serial signals. The serial signals are transmitted through corresponding TX antennas to the receiving apparatus.

Although not illustrated in FIG. 1A, a feedback information receiver (not illustrated) receives feedback information such as a CQI and a NACK signal, and provides the received feedback information to the S/P converters 102-1˜102-K and a MAP information transmitter (not illustrated). If the feedback information such as the CQI and the NACK signal is received, the MAP information transmitter adds 1-bit information, which indicates that hidden pilots are to be added to TX signals, to MAP information prior to transmission to the receiving apparatus.

Referring to FIG. 1B, the S/P converters 111-1˜111-K convert data, which are received through corresponding RX antennas, into parallel signals, and output the parallel signals to the CP removers 112-1˜112-K. The CP removers 112-1˜-112-K remove CPs from input signals, and output the resulting signals (i.e., CP-removed signals) to the primary FFT processors 113-1-1˜113-K-1 and the primary channel estimators 114-1-1˜114-K-1 or to the secondary FFT processors 113-1-2˜113-K-2. For example, if MAP information including 1-bit information, which indicates that hidden pilots are to be added to TX signals, is received from the transmitting apparatus, the CP removers 112-1˜112-K output the CP-removed signals to the primary FFT processors 113-1-1˜113-K-1 and the primary channel estimators 114-1-1˜114-K-1. On the other hand, if the MAP information including the 1-bit information is not received from the transmitting apparatus, the CP removers 112-1˜112-K output the CP-removed signals to the secondary FFT processors 113-1-2˜113-K-2.

The primary FFT processors 113-1-1˜113-K-1 FFT-process input time-domain signals into frequency-domain signals, and output the frequency-domain signals to the primary receivers 115-1-1˜115-K-1. The primary channel estimators 114-1-1˜114-K-1 remove interferences from input signals in terms of cyclic hidden pilots, estimate channels using the interference-removed signals (i.e., the hidden pilots of self-users), convert the estimated channels in a frequency-domain, and output the resulting frequency-domain data to the primary receivers 115-1-1˜115-K-1.

The primary receivers 115-1-1˜115-K-1 subcarrier-demap the input frequency-domain signals, remove the hidden pilots from the demapped signals using the estimated channels, detect signals using the estimated channels, and output the detected signals to the inverse precoders 116-1˜116-K. The inverse precoders 116-1˜116-K inverse-precode signals corresponding to the precoding signals of the transmitting apparatus, and output the resulting signals to the primary P/S converters 117-1-1˜117-K-1. The primary P/S converters 117-1-1˜117-K-1 convert input signals into serial signals, and output the serial signals to the primary demodulators 118-1-1˜118-K-1. The primary demodulators 118-1-1˜118-K-1 demodulate input signals in a demodulation scheme corresponding to a modulation scheme of the transmitting apparatus, and output the resulting user data.

The secondary FFT processors 113-1-2˜113-K-2 FFT-process input time-domain signals into frequency-domain signals, output the frequency-domain signals to the secondary receivers 115-1-2˜115-K-2, and output signals corresponding to preambles in the frequency-domain signals to the secondary channel estimators 114-1-2˜114-K-2. The secondary channel estimators 114-1-2˜114-K-2 estimate channels using the preambles, and output the estimated channels to the secondary receivers 115-1-2˜115-K-2. The secondary receivers 115-1-2˜115-K-2 subcarrier-demap the input frequency-domain signals, detect signals from the demapped signals using the estimated channels, and output the detected signals to the secondary P/S converters 117-1-2˜117-K-2. The secondary P/S converters 117-1-2˜117-K-2 convert input signals into serial signals, and output the serial signals to the secondary demodulators 118-1-2˜118-K-2. The secondary demodulators 118-1-2˜118-K-2 demodulate input signals in a demodulation scheme corresponding to a modulation scheme of the transmitting apparatus, and output the resulting user data.

Although not illustrated in FIG. 1B, a decoder (not illustrated) decodes the demodulated data at a predetermined coding rate, and outputs the recovered information data to a CRC checker (not illustrated). The CRC checker detects an error in the input information data. If there is no error in the input information data, the user data are transmitted to a medium access control (MAC) layer. If there is an error in the input information data, feedback information such as a NACK signal and a CQI is generated and transmitted to the transmitting apparatus. Also, a MAP information receiver (not illustrated) receives MAP information from the transmitting apparatus and outputs the received MAP information to the CP removers 112-1˜112-K.

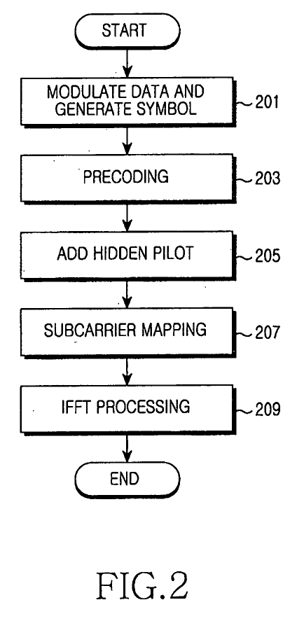

FIG. 2 is a flowchart illustrating a procedure for transmitting data from the transmitting apparatus in an OFDMA mobile communication system according to an embodiment of the present invention. The following description is made on the assumption that the total number of subcarriers is P and each of K users is allocated N subcarriers.

Referring to FIG. 2, in step 201, the transmitting apparatus modulates data of a user k in an M-ary PSK modulation scheme to generate an (M×1)-sized i^{th} symbol block sₖ(i) including a total of M modulation symbols.

In step 203, the transmitting apparatus multiplies the symbol block sₖ(i) by an (N×M)-sized precoding signal Pₖ to generate a precoded signal. In step 205, the transmitting apparatus adds an (N×1)-sized hidden pilot tₖ to the precoded signal.

The precoding signal and the hidden pilot are generated using a polyphase sequence having the near-optimal auto and cross-correlation characteristics. The precoding signal and the hidden pilot are generated as follows: First, a p-nary sequence s(n) with a length of N₁=p^{r}−1 is generated (where p is a prime number and r is an integer greater than 1). Using the generated sequence s(n), a polyphase sequence set C including a total of N₁ polyphase sequences cᵢ is generated as Equation (1):

$$C = [ {c}_{0} , {c}_{1} , … , {c}_{{N}_{1} - 1} ] \\ {c}_{i} = [ {c}_{i} ( 0 ) , {c}_{i} ( 1 ) , … , {c}_{i} ( {N}_{l} - 1 ) ] \\ {c}_{i} ( n ) = \frac{1}{\sqrt{{N}_{l}}} exp [ j 2 π ( s ( n ) / p + ⅈ \cdot n / {N}_{l} ) ] \qquad ( 1 )$$

The precoding signal may be generated using the (N₁−1) polyphase sequences and the hidden pilot may be generated using the remaining one polyphase sequence, as Equation (2):
Pₖ=[c₀, c₁, . . . , c_{N}_{₁}₋₂] (k=1, . . . , K)
tₖ=c_{N}_{₁}₋₁ (k=1, . . . , K) (2)

In step 207, the transmitting apparatus maps the resulting signals of step 205 to N subcarriers allocated to the respective users. In step 209, the transmitting apparatus IFFT-processes the subcarrier-mapped signals (i.e., the resulting signals of step 207).

A total of K user signals resulting from the IFFT processing can be expressed as Equation (3):

$$u ( i ) = {\sum }_{k = 1}^{K} {u}_{k} ( i ) \\ {u}_{k} ( i ) = {F}^{H} {Ψ}_{k} ( {P}_{k} {s}_{k} ( i ) + {t}_{k} ) = {A}_{k} {s}_{k} ( i ) + {b}_{k} \qquad ( 3 )$$

where uₖ(i) denotes a TX signal of a user k, Ψₖ denotes a P×N subcarrier mapping matrix of the user k, and F^{H} denotes a P×P IFFT matrix.

Thereafter, as expressed in Equation (4), the transmitting apparatus adds a CP with a length of L_{CP} to the signal resulting from the IFFT processing, converts the CP-added parallel data into serial data, converts the serial digital data into analog data, and transmits the resulting data through the antennas to the corresponding terminals:
u_{CP}(i)=T_{CP}u(i) (4)
where T_{CP}=[I_{CP}^{T}I_{N}^{T}]^{T}, T_{CP} denotes a CP insertion matrix, I_{N}^{T} denotes an original signal, I_{CP}^{T} denotes a copy of a predetermined end of the original signal I_{N}^{T}, I_{CP}^{T}=[O_{L}_{_{CP}}_{×(N-L}_{_{CP}}₎I_{L}_{_{CP}}]^{T}, I_{L}_{_{CP}} denotes an L_{CP}-sized identity matrix, and O_{L}_{_{CP}}_{×}_{(N-L}_{_{CP}}₎ denotes an L_{CP}×(N-L_{CP}) zero matrix.

Thereafter, the transmitting apparatus ends the data transmitting procedure. The total TX signal power is shared by the data and the hidden pilot.

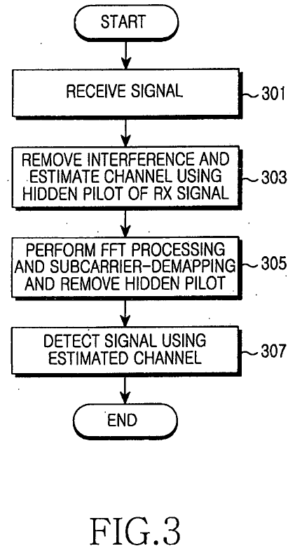

FIG. 3 is a flowchart illustrating a procedure for receiving data at the receiving apparatus in an OFDMA mobile communication system according to an embodiment of the present invention.

Referring to FIG. 3, the receiving apparatus receives a signal from the transmitting apparatus in step 301. The receiving apparatus converts the received signal into digital data, converts the serial digital data into parallel data, and removes a CP from the parallel signal. The k′^{th} user receives data of other users, as well as its own data, that is, data of the k^{th} user transmitted by the transmitting apparatus.

The CP-removed RX signal of the k′^{th} user can be expressed as Equation (5):

$${r}_{CP , {k}^{′}} ( i ) = {H}_{{k}^{′}} u ( i ) + w ( i ) = {H}_{{k}^{′}} \cdot ( {\sum }_{k = 1}^{K} {u}_{k} ( i ) ) + w ( i ) \qquad ( 5 )$$

where H_{k′} denotes an N×N circulant matrix whose first column is [h_{k′}^{T}0, . . . , 0]^{T}, h_{k′}=[h_{k′}(0), . . . , h_{k′}(L)]^{T}, h_{k′} denotes an (L+1)×1 channel vector, and w(i) denotes a white noise with a variance of σ_{w}².

Using Equation (3), Equation (5) can be expressed as Equation (6):

$$\begin{matrix}{r}_{CP , {k}^{′}} ( i ) = {H}_{{k}^{′}} \cdot [ {\sum }_{k = 1}^{K} {A}_{k} {s}_{k} ( i ) ] + {H}_{{k}^{′}} \cdot [ {\sum }_{k = 1}^{K} {b}_{k} ] + w ( i ) \\ = {H}_{{k}^{′}} \cdot [ {\sum }_{k = 1}^{K} {A}_{k} {s}_{k} ( i ) ] + [ {\sum }_{k = 1}^{K} {B}_{k} ] \cdot {h}_{{k}^{′}} + w ( i )\end{matrix} \qquad ( 6 )$$

where Bₖ denotes an N×(L+1) circulant matrix whose first column is [bₖ^{T}(i), 0, . . . , 0]^{T}, that is, a cyclic hidden pilot. That is, in order to estimate a channel hₖ of the k′^{th} user, a hidden pilot

$$[ {\sum }_{k = 1}^{K} {b}_{k} ]$$

of every user, which is received through a cyclic channel Hₖ for the k′^{th} user, can be transformed into a cyclic hidden pilot

$$[ {\sum }_{k = 1}^{K} {B}_{k} ]$$

for every user, which is received through a channel vector hₖ of the k′^{th} user.

Because the signals received by the receiving apparatus are signals obtained by adding hidden pilots to data signals for all the users, a data signal of a predetermined user, data signals of other users, and hidden pilots of other users act as interferences in terms of a hidden pilot of the predetermined user. Therefore, in step 303, the receiving apparatus removes an interference signal from an RX signal in terms of a cyclic hidden pilot, and estimates a channel using the interference-removed signal, that is, the hidden pilot of the predetermined user.

The interference-removed RX signal of the k′^{th} user can be expressed as Equation (7):

$$\begin{matrix}{y}_{{k}^{′}} ( i ) = {B}_{{k}^{′}}^{H} {r}_{CP , {k}^{′}} ( i ) \\ = {B}_{{k}^{′}}^{H} {H}_{{k}^{′}} \cdot ( {\sum }_{k = 1}^{K} {A}_{k} {s}_{k} ( i ) ) + {B}_{{k}^{′}}^{H} ( {\sum }_{k = 1}^{K} {B}_{k} ) {h}_{{k}^{′}} + {B}_{{k}^{′}}^{H} w ( i )\end{matrix} \qquad ( 7 )$$

where

$${B}_{{k}^{′}}^{H} {H}_{{k}^{′}} \cdot ( {\sum }_{k = 1}^{K} {A}_{k} {s}_{k} ( i ) )$$

is an interference due to data signals of all the users in terms of the hidden pilot of the k′^{th} user.

The

$${B}_{{k}^{′}}^{H} {H}_{{k}^{′}} \cdot ( {\sum }_{k = 1}^{K} {A}_{k} {s}_{k} ( i ) )$$

must approach 0. To this end, the cyclic hidden signal and the precoding signal resulting from the subcarrier mapping and the IFFT processing must satisfy Equation (8):
B_{k′}^{H}A_{k,i}→0, ∀iε[1,M] and kε{1,K] (8)
where A_{k,i} denotes a column-wise circulant matrix using the i^{th} column of Aₖ.

An interference due to hidden pilots of other users, except the hidden pilot of the k′^{th} user, must also be removed for more accurate channel estimation. To this end, the cyclic hidden pilot must satisfy Equation (9):

$${B}_{{k}^{′}}^{H} {B}_{k} \to \{ \begin{matrix}cI , {k}^{′} = k ( c \text{:} constant ) \\ 0 , {k}^{′} \neq k\end{matrix} \qquad ( 9 )$$

That is, if the k^{th} user data transmitted by the transmitting apparatus are the k′^{th} user data, B_{k′}^{H}Bₖ must satisfy cI. If the k^{th} user data are data of other users, B_{k′}^{H}Bₖ must be 0.

Using the interference-removed RX signal of the k′^{th} user, that is, the hidden pilot of the predetermined user, a channel is estimated in a minimum mean square error (MMSE) scheme, for example. The MMSE channel estimation using the hidden pilot of the predetermined user can be expressed as Equation (10):
h_{k′}=Rₕ_{ₖ}B_{k′}^{H}B_{k′}(B_{k′}^{H}B_{k′}Rₕ_{ₖ}B_{k′}^{H}B_{k′}+R_{z})⁻¹y_{k′}(i) (10)
where Rₕ_{ₖ} denotes a channel correlation matrix, R_{z}=E{z(i)z^{H}(i)}=Rᵥ+σ_{w}²B_{k′}^{H}B_{k′}, and Rᵥ=E{v(i)v^{H}(i)}.

In step 305, the receiving apparatus FFT-processes the CP-removed RX signal and subcarrier-demaps the FFT-processed signal.

The FFT-processed and subcarrier-demapped RX signal of the k′^{th} user can be expressed as Equation (11):

$$\begin{matrix}{\tilde{X}}_{{k}^{′}} ( i ) = {Ψ}_{{k}^{′}}^{H} {Fr}_{CP , {k}^{′}} ( i ) \\ = {\sum }_{k = 1}^{K} {Ψ}_{{k}^{′}}^{H} {FH}_{{k}^{′}} {F}^{H} {Ψ}_{k} ( {P}_{k} {S}_{k} ( i ) + {t}_{k} ) + {Ψ}_{{k}^{′}}^{H} Fw ( i ) \\ = {D}_{H , k} {P}_{k} {s}_{k} ( i ) + {D}_{H , k} {t}_{k} + {w}_{F , k} ( i )\end{matrix} \qquad ( 11 )$$

where D_{H,k} denotes a matrix obtained by diagonalizing the channel frequency responses of the k^{th} user, which uses the characteristics of a subcarrier allocation matrix expressed as Equation (12):

$${Ψ}_{{k}^{′}}^{H} {Ψ}_{k} = \{ \begin{matrix}{I}_{M} , & {k}^{′} = k \\ 0 , & otherwise\end{matrix} \qquad ( 12 )$$

That is, for TX signals of all the users, which are spread in a frequency domain according to the subcarrier mapping of the transmitting apparatus, a subcarrier allocation matrix is used to extract data of the k′^{th} user (i.e., the k^{th} user data transmitted by the transmitting apparatus) through the subcarrier demapping and to remove data of other users.

Because a hidden pilot portion in Equation (11) is not used in TX signal detection, the receiving apparatus removes the hidden pilot portion from the subcarrier-demapped RX signal in step 305, thereby minimizing an interference due to the hidden pilot. The hidden pilot portion may be removed by making the D_{H,k} be 0, which may be performed using the estimated channel. For example, the hidden pilot portion is removed by making the D_{H,k} be 0 by using a matrix \hat{D}_{H,k}, which is obtained by diagonalizing the frequency responses of the estimated channel.

The RX signal of the k′^{th} user (i.e., the k^{th} user), from which the hidden pilot portion is removed, can be expressed as Equation (13):
Xₖ(i)=D_{H,k}Pₖsₖ(i)+(D_{H,k}−\hat{D}_{H,k})tₖ+w_{F,k}(i) (13)

In step 307, using the estimated channel, the receiving apparatus detects a signal in an MMSE scheme, for example.

The detected signal of the k^{th} user can be expressed as Equation (14):

$${{s}^{⋒}}_{k} ( i ) = {G}_{k} ( i ) {x}_{k} ( i ) \\ \begin{matrix}{G}_{k} ( i ) = {P}_{k}^{H} \frac{{P}_{s}}{M} {{\hat{D}}_{H , k} ( \frac{{P}_{s}}{M} {\hat{D}}_{H , k} {P}_{k} {P}_{k}^{H} {\hat{D}}_{H , k}^{H} + {R}_{η , k} ( i ) )}^{- 1} \\ = {P}_{k}^{H} {Λ}_{k} ( i )\end{matrix} \qquad ( 14 )$$

where Pₛ denotes the TX signal power for each user, R_{η,k}(i)=E{ηₖ(i)ηₖ^{H}(i)}, ηₖ(i)=\tilde{D}_{H,k}(i)(Pₖsₖ(i)+tₖ)+w_{F,k}(i), and \tilde{D}_{H,k}(i) denotes D_{H,k}−\hat{D}_{H,k}. For example, an MMSE receiver Λₖ(i) and an inverse precoder Pₖ^{H} may be used to obtain the detected signal ŝₖ(i) from the RX signal of the k^{th} user from which the hidden pilot portion is removed.

A cross-correlation matrix of an error \tilde{s}ₖ(i)=sₖ(i)−ŝₖ(i) between the actual TX signal and the detected signal of the k^{th} user can be expressed as Equation (15):

$${R}_{\tilde{s} , k} ( i ) = E \{ {\tilde{s}}_{k} ( i ) {\tilde{s}}_{k}^{H} ( i ) \} = {( \frac{M}{{P}_{s}} {I}_{M} + {P}_{k}^{H} {\hat{D}}_{H , k}^{H} {R}_{η}^{- 1} {\hat{D}}_{H , k} {P}_{k} )}^{- 1} \qquad ( 15 )$$

If

$${P}_{k} {P}_{k}^{H} = \frac{M}{N} {I}_{N} and {t}_{k} {t}_{k}^{H} = \frac{{P}_{t}}{N} {I}_{N} ,$$

R_{\tilde{s},k}(i) is diagonalized and error variance values corresponding to the m^{th} TX signal of the k^{th} user are maintained uniformly. That is, the TX signals of each user are evenly spread in a frequency domain, resulting in the equalization effects in the frequency domain for error values. If Pₖ^{H}Pₖ=I_{M} is additionally satisfied, the signals spread in the frequency domain can be collected again, thereby achieving the frequency diversity gain.

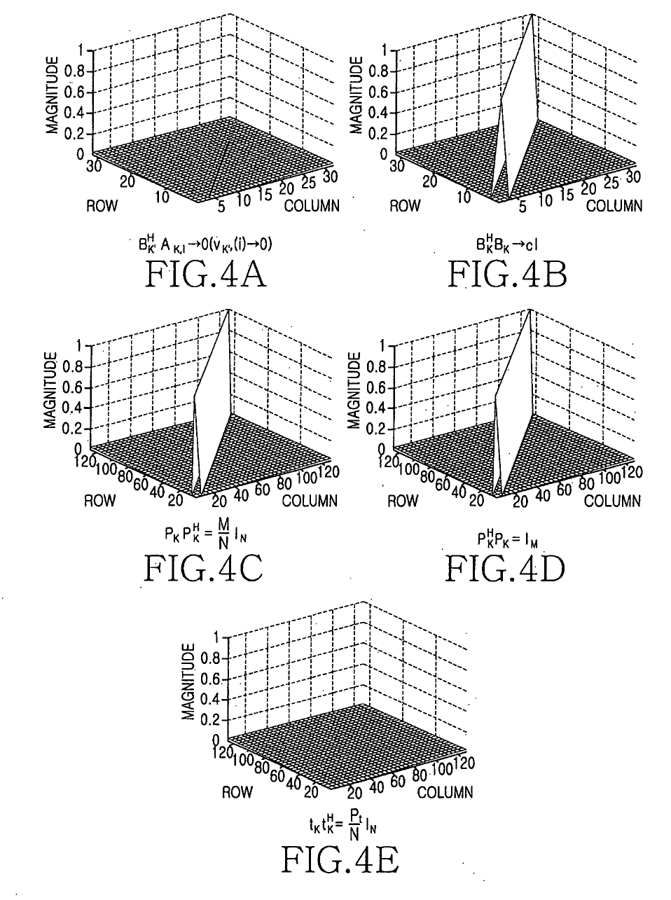

FIGS. 4A to 4E are diagrams for verifying whether the precoders and the hidden pilots according to the present invention satisfy characteristics necessary for the channel estimation and the receiver design. Table 1 illustrates design parameters for the above verification, where Pₜ denotes TX power allocated to the hidden pilot.

TABLE 1

Parameter

| | p | r | N_{I} | L | Pₜ | K |
|---|---|---|---|---|---|---|
| Set Value | 2 | 7 | 127 | 11 | 1 | 2 |

It can be seen from FIGS. 4A to 4E that the precoding signal and the hidden pilot have characteristics that must be satisfied in the channel estimation and the RX signal detection.

Thereafter, the receiving apparatus ends the data receiving procedure.

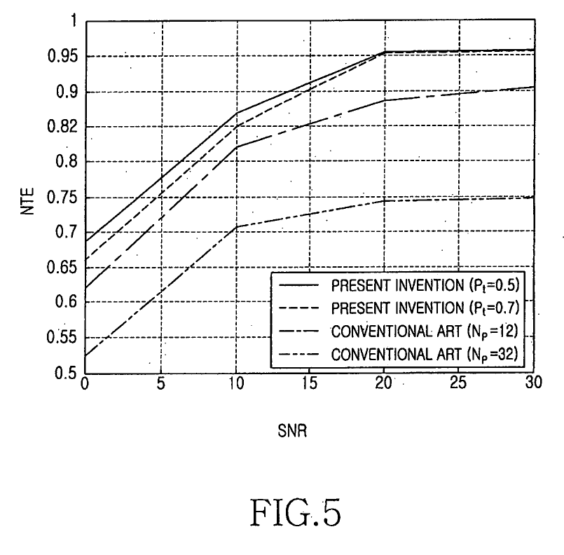

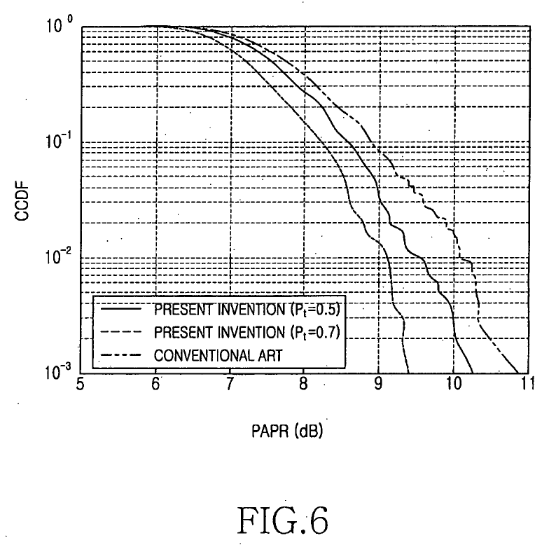

FIGS. 5 and 6 are graphs for comparing the performance of the present invention with the performance of the conventional art. The main object of the present invention is to prevent a waste of bandwidth, which is due to the use of the conventional pilot, and reduce a high PAPR at an uplink of the OFDMA system for high-rate data transmission, by adding the hidden pilot, which is generated using a polyphase sequence, to a TX signal prior to transmission to the receiving apparatus. A normalized transmission efficiency (NTE), which is obtained by averaging a transmission efficiency by the number of users, and a PAPR are used as performance criteria. Table 2 illustrates parameter values set for the performance comparison.

TABLE 2

| | Value (Proposed | Value (Conventional |
|---|---|---|
| Parameter | System) | System) |
| Modulation | QPSK | QPSK |
| Number of data symbols | 126 | 127 |
| per user | | |
| Number of data | 127 | 115/95 |
| subcarriers per user | | |
| Number of pilot | 128 | 12/32 |
| subcarriers per user | | |
| Number of null | 1 | 1 |
| subcarriers per user | | |
| Number of subcarriers | 128 | 128 |
| used per user | | |
| Number of users | 2 | 2 |
| Channel | i.i.d 12-tap Exp. | i.i.d 12-tap Exp. |
| CP length | 12 | 12 |

For the performance comparison, a conventional OFDMA system transmitting a pilot in a frequency domain is used as the conventional system. Because hidden pilots are added to TX signals prior to transmission, the proposed system must adjust the power of the hidden pilots and the TX signals, instead of adjusting the number of the TX signals and the pilot signals. The channel used is an i.i.d 12-tap exponential decaying channel, and a channel changes with each symbol transmission.

FIG. 5 is a graph for comparing the NTE of the present invention with the NTE of the conventional art. Referring to FIG. 5, the proposed system allocates 50% or 70% power (Pₜ=0.5 or 0.7) to the hidden pilot when the total TX signal power is normalized to 1. The convention system uses 12 or 32 subcarriers as pilot signals (Nₚ=12 or 32). It can be seen from the graph of FIG. 5 that the proposed system can provide higher transmission efficiency than the conventional system. Due to a waste of bandwidth for channel estimation, the conventional case of Nₚ=32 provides a lower transmission efficiency than the conventional case of Nₚ=12, and the proposed case of Pₜ=0.7 provides a lower transmission efficiency than the proposed case of Pₜ=0.5. The reason for this is that the power allocated to the TX signal decreases with an increase in the power allocated to the hidden pilot, leading to an increase in the error probability. In conclusion, it can be seen that the proposed OFDMA system using the precoding signal and the hidden pilot according to the present invention can increase the transmission efficiency and can transmit data at a higher rate, when compared to the conventional OFDMA system.

FIG. 6 is a graph for comparing the peak-to-average power ratio (PAPR) of the present invention with the PAPR of the conventional art. It can be seen from the graph of FIG. 6 that the PAPR of the proposed system is lower than the PAPR of the conventional system. In particular, the PAPR performance increases with an increase in the power allocated to the hidden pilot. The reason for this is that the average power of the TX signal increases with an increase in the power allocated to the hidden pilot, which reduces the PAPR of the TX signal generated due to data transmission. In conclusion, it can be seen that the proposed OFDMA system can reduce the PAPR problem that occurs under an uplink situation.

In accordance with the present invention as described above, the transmitting apparatus of the OFDMS mobile communication system adds the hidden pilot, which is generated using the polyphase sequence, to the TX signal prior to transmission to the receiving apparatus, and the receiving apparatus estimates a channel using the hidden pilot. Therefore, a waste of bandwidth due to the use of the conventional pilot signal is reduced and a data rate is increased, thereby increasing the overall transmission efficiency of the system. Also, the average power of OFDMA signals is increased and the possible range of signal strength is reduced, thereby reducing the PAPR.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for transmitting data in a mobile communication system, comprising the steps of:
modulating a symbol data to be transmitted in a predetermined modulation scheme;
generating a hidden pilot using a sequence with auto and cross-correlation characteristics;
precoding the modulated data with the precoding signal having the auto and cross-correlation characteristics; and
adding the hidden pilot to the precoded signal.

2. The method of claim 1, further comprising the steps of:
mapping the signal having the hidden pilot added thereto to a subcarrier allocated to the corresponding user; and
inverse fast Fourier transform (IFFT)-processing the signal mapped to the subcarrier, prior to transmission.

3. The method of claim 1, wherein the precoding signal is generated using a poly-phase sequence.

4. The method of claim 1, wherein the mobile communication system transmits to a target receiver an information whether the system precodes the modulated data.

5. The method of claim 4, further comprising the step of:
transmitting the information whether the system precodes the modulated data through a MAC (medium access control) layers.

6. The method of claim 1, wherein the sequence is a polyphase sequence expressed as the following equation:
$$C = [ {c}_{0} , {c}_{1} , … , {c}_{{N}_{1} - 1} ]$$
$${c}_{i} = [ {c}_{i} ( 0 ) , {c}_{i} ( 1 ) , … , {c}_{i} ( {N}_{1} - 1 ) ]$$
$${c}_{i} ( n ) = \frac{1}{\sqrt{{N}_{1}}} exp [ j2π ( s ( n ) / p + ⅈ \cdot n / {N}_{1} ) ]$$
where s(n) denotes a p-nary sequence with a length of N₁=p^{r}−1, p is a prime number, r is an integer greater than 1, cᵢ denotes a polyphase sequence generated using the sequence s(n), C denotes a polyphase sequence set including a total of N₁ polyphase sequences cᵢ,
wherein the precoding signal is generated using the (N₁−1) polyphase sequences and the hidden pilot is generated using the remaining one polyphase sequence.

7. The method of claim 1, further comprising the step of:
inserting a CP (cyclic prefix) in the modulated symbol data

8. An apparatus for transmitting data in a mobile communication system, comprising:
a modulator for modulating a user signal in a predetermined modulation scheme;
a precoder for precoding the modulated user signal using a precoding signal generated using a sequence with auto and cross-correlation characteristics; and
a adder for adding a hidden signal, generated using the sequence, to the precoded signal.

9. The apparatus of claim 8, further comprising:
a subcarrier mapper for mapping the signal having the hidden pilot added thereto to a subcarrier allocated to the corresponding user; and
an inverse fast Fourier transform (IFFT) processor for IFFT-processing the signal mapped to the subcarrier.

10. The apparatus of claim 8, wherein the sequence is a polyphase sequence expressed as the following equation:
$$C = [ {c}_{0} , {c}_{1} , … , {c}_{{N}_{1} - 1} ]$$
$${c}_{i} = [ {c}_{i} ( 0 ) , {c}_{i} ( 1 ) , … , {c}_{i} ( {N}_{1} - 1 ) ]$$
$${c}_{i} ( n ) = \frac{1}{\sqrt{{N}_{1}}} exp [ j2π ( s ( n ) / p + ⅈ \cdot n / {N}_{1} ) ]$$
where s(n) denotes a p-nary sequence with a length of N₁=p^{r}−1, p is a prime number, r is an integer greater than 1, cᵢ denotes a polyphase sequence generated using the sequence s(n), and C denotes a polyphase sequence set including a total of N₁ polyphase sequences cᵢ,
wherein the precoding signal is generated using the (N₁−1) polyphase sequences and the hidden pilot is generated using the remaining one polyphase sequence.

11. A method for receiving data in a mobile communication system, comprising the steps of:
removing a cyclic prefix (CP) from a receive (RX) signal; and
removing the remaining signal except a hidden pilot of a self-user from the CP-removed RX signal using a cyclic hidden pilot, and estimating a channel using only the hidden pilot of a self-user.

12. The method of claim 11, further comprising the steps of:
fast Fourier transform (FFT)-processing the CP-removed RX signal;
subcarrier-demapping the FFT-processed signal;
removing the hidden pilot from the subcarrier-demapped signal using the estimated channel; and
detecting a signal using the estimated channel.

13. The method of claim 12, wherein the channel estimating step and the signal detecting step are performed using a minimum mean square error (MMSE) scheme.

14. The method of claim 11, wherein the hidden pilot is generated using a polyphase sequence with auto & cross-correlation characteristics.

15. The method of claim 11, wherein the step of removing the remaining signal from the CP-removed RX signal is performed by multiplying the Hermitian of the cyclic hidden pilot as the following equation:
$${B}_{{k}^{′}}^{H} {A}_{k , i} \to 0 , ∀ ⅈ ∈ [ 1 , M ] and k ∈ \{ 1 , K ]$$
$${B}_{{k}^{′}}^{H} {B}_{k} \to \{ \begin{matrix}cI , & {k}^{′} = k & ( c \text{:} constant ) \\ 0 , & {k}^{′} \neq k & \end{matrix}$$
where Bₖ denotes a circulant matrix whose first column is [bₖ^{T}(i), 0, . . . , 0]^{T}, that is, the cyclic hidden pilot, bₖ=F^{H}Ψₖtₖ, tₖ denotes an N×1 hidden pilot, Ψₖ denotes a P×N subcarrier mapping matrix of a user k, F^{H} denotes a P×P IFFT matrix, A_{k,i} denotes a column-wise circulant matrix using the i^{th} column of Aₖ, K denotes the total number of users, M denotes a modulation order, k denotes a user index from the standpoint of a transmitting side, and k′ denotes a user index from the standpoint of a receiving side, wherein the k^{th} user data transmitted by the transmitting side is the data of the k′^{th} user.

16. The method of claim 12, wherein the hidden pilot is removed from the subcarrier-demapped signal using the following equation:
Xₖ(i)=D_{H,k}Pₖsₖ(i)+(D_{H,k}−\hat{D}_{H,k})tₖ+w_{F,k}(i)
where D_{H,k} denotes a matrix obtained by diagonalizing the channel frequency responses of a k^{th} user, \hat{D}_{H},k denotes a matrix obtained by diagonalizing the frequency responses of the estimated channel, the hidden pilot is removed by making the D_{H,k} be 0 using the D_{H,k}, Pₖ denotes an (N×M)-sized precoding signal, sₖ(i) denotes an (M×1)-sized i^{th} symbol block including a total of M modulation symbols generated by modulating data of a user k in an M-ary PSK modulation scheme, tₖ denotes an N×1 hidden pilot, and w_{F,k}(i) denotes a noise signal.

17. The method of claim 16, wherein the hidden pilot and the precoding signal satisfy the following equation:
$${P}_{k} {P}_{k}^{H} = \frac{M}{N} {I}_{N} , {t}_{k} {t}_{k}^{H} = \frac{{P}_{t}}{N} {I}_{N} , {P}_{k}^{H} {P}_{k} = {I}_{M}$$
where Pₜ denotes TX power allocated to the hidden pilot, N denotes the number of subcarriers allocated to the k^{th} user, and M denotes a modulation order.

18. An apparatus for receiving data in a mobile communication system, comprising:
a CP remover for removing a cyclic prefix (CP) from a receive (RX) signal; and
a channel estimator for removing the remaining signal except a hidden pilot of a self-user from the CP-removed RX signal using a cyclic hidden pilot, and estimating a channel using only the hidden pilot of a self-user.

19. The apparatus of claim 18, further comprising:
a receiver for fast Fourier transform (FFT)-processing the CP-removed RX signal, subcarrier-demapping the FFT-processed signal, removing the hidden pilot from the subcarrier-demapped signal using the estimated channel, and detecting a signal using the estimated channel; and
an inverse precoder for inverse-precoding the detected signal using an inverse precoding signal corresponding to a precoding signal of a transmitting side.

20. The apparatus of claim 19, wherein the hidden pilot is generated using a polyphase sequence with auto & cross-correlation characteristics.

21. The apparatus of claim 19, wherein the hidden pilot and the precoding signal satisfy the following equation:
$${P}_{k} {P}_{k}^{H} = \frac{M}{N} {I}_{N} , {t}_{k} {t}_{k}^{H} = \frac{{P}_{t}}{N} {I}_{N} , {P}_{k}^{H} {P}_{k} = {I}_{M}$$
where Pₜ denotes TX power allocated to the hidden pilot, N denotes the number of subcarriers allocated to the k^{th} user, and M denotes a modulation order.

22. An apparatus for transceiving data in a mobile communication system, comprising:
a receiving apparatus for estimating a channel using only a preamble, decoding a receive (RX) signal using the estimated channel, transmitting feedback information for transmission of a hidden pilot to a transmitting apparatus if there is an error in the decoding operation, receiving a TX signal having a hidden pilot added thereto from the transmitting apparatus after MAP information including information, which indicates that the hidden pilot is to be added to a TX signal prior to transmission to the receiving apparatus, is received from the transmitting apparatus, estimating a channel using the added hidden pilot, and decoding an RX signal using the estimated channel; and
a transmitting apparatus for transmitting only a TX signal to the receiving apparatus, transmitting the MAP information to the receiving apparatus if the feedback information is received from the receiving apparatus, and transmitting the TX signal having the hidden pilot added thereto to the receiving apparatus.

23. The apparatus of claim 22, wherein the feedback information is a channel quality indicator (CQI) or a Negative ACKnowledgement (NACK) signal.

24. The apparatus of claim 22, wherein the hidden pilot is generated using a polyphase sequence with auto & cross-correlation characteristics.
